(19) United States
(12) Patent Application Publication
(10) Pub. No.: US 2006/0196555 A1
(43) Pub. Date: Sep. 7, 2006

(54) Control stop

(75) Inventor: Chih-Chen Yen, Taipei City (TW)

Correspondence Address: TROXELL LAW OFFICE PLLC, SUITE 1404, 5205 LEESBURG PIKE, FALLS CHURCH, VA, 22041, US

(73) Assignee: Flushtech Corporation

(21) Appl. No.: 11/068,817

(22) Filed: Mar. 2, 2005

(51) Int. Cl. F16K 15/02

(52) U.S. Cl. 137/540

(57) ABSTRACT

A control stop includes a body housing a plug which has a retaining ring coupled on one end, a water regulation rod screwed on a seat located below the plug, and an elastic element coupled on a center strut of the seat. The elastic element has one end pressing the bottom of the plug. The water regulation rod may be turned and moved upwards and downwards to form a gap between the water regulation rod and the bottom of the plug. When a flush valve coupled with the control stop is flushing, water pressure pushes the retaining ring to move the plug downwards and alter the gap to form an opening to allow water to pass through. In the non-flushing condition, the plug is pushed upwards by the elastic element so that the retaining ring seals the outer bottom end of the orifice to stop water flow.

### BACKGROUND OF THE INVENTION

1. Field of the Invention

The invention relates to a control stop and particularly to a control stop that can automatically block a water inlet to prevent back siphonage and drawing sewage of toilet devices into the water source piping.

2. Description of the Prior Art

A control stop 10 is to bridge a water source end 11 and a flush valve 12 as shown in FIG. 1. It controls opening size of the water inlet to control water intake to meet water requirement of the flush valve 12 at the rear end. The conventional control stop mainly aims to provide water regulation function like a faucet. It has a water regulation valve which often is set at a fixed position with an opening to receive water flow. While it allows water to enter through the inlet end to the flush valve, the constant open nature also results in water counter flow. When the piping at the rear end of the outlet of the flush valve has back siphonage taking place due to a vacuum condition, sewage of toilet devices 13 such as toilets and urinals could flow back. As the flush valve does not have any feature to stop the counter flow, the sewage could flow back to the clean water source and cause contamination of the drinking water.

### SUMMARY OF THE INVENTION

In view of the control stop is the first water control device in the entire flush system, and the last control point of sewage counter flow, the primary object of the present invention is to provide a control stop that has an elastic and movable retaining ring which, according to the opening and closing of the flush valve at the rear end of the piping system, can flexibly open water inlet to allow water to flow to the flush valve at the rear end, or close the water inlet to prevent the sewage from flowing back to ensure that the clean water in the piping system is not contaminated.

To achieve the foregoing object, the control stop of the invention includes a body which has an orifice abutting a water inlet to house a plug. The plug has one end remote from the water inlet end to couple with a retaining ring. A water regulation rod is provided which is screwed on a seat located on a lower side of the plug. The water regulation rod has a strut on one end and a regulation end on other end. The seat is screwed on one end of the body of the control stop remote from the water inlet, and has an opening leading to the regulation end of the water regulation rod. An elastic element is coupled on the strut of the seat. The strut is screwed on the water regulation rod.

By means of the control stop of the invention, the water regulation rod may be turned and moved upwards or downwards so that the strut end and the bottom of the plug form a gap. When the flush valve is opened, water pressure of the flush water pushes the retaining ring to move the plug downwards and also alter the gap, so that the retaining ring and outer bottom end of the orifice form an opening to allow water to pass through, and the water can flow from the inlet of the control stop to the outlet. On the contrary, when the flush valve stops flushing, the plug is pushed upwards by the elastic element on the lower side so that the retaining ring seals the outer bottom end of the orifice. And water flow between the inlet of the control stop and the outlet is blocked. Hence when the flush valve stop flushing, back siphonage may be avoided and counter flow of the sewage to the water source may be prevented.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional control stop in a use condition;

FIG. 2 is a sectional view of the control stop of the invention in a non-flushing condition;

FIG. 3 is a sectional view of the control stop of the invention in a flushing condition;

FIG. 4 is a schematic view of the invention according to FIG. 2, with a gap formed between the plug and the water regulation rod; and

FIG. 5 is a schematic view of the invention with the plug and the orifice in a coupled condition

### DESCRIPTION OF THE PREFERRED EMBODIMENT

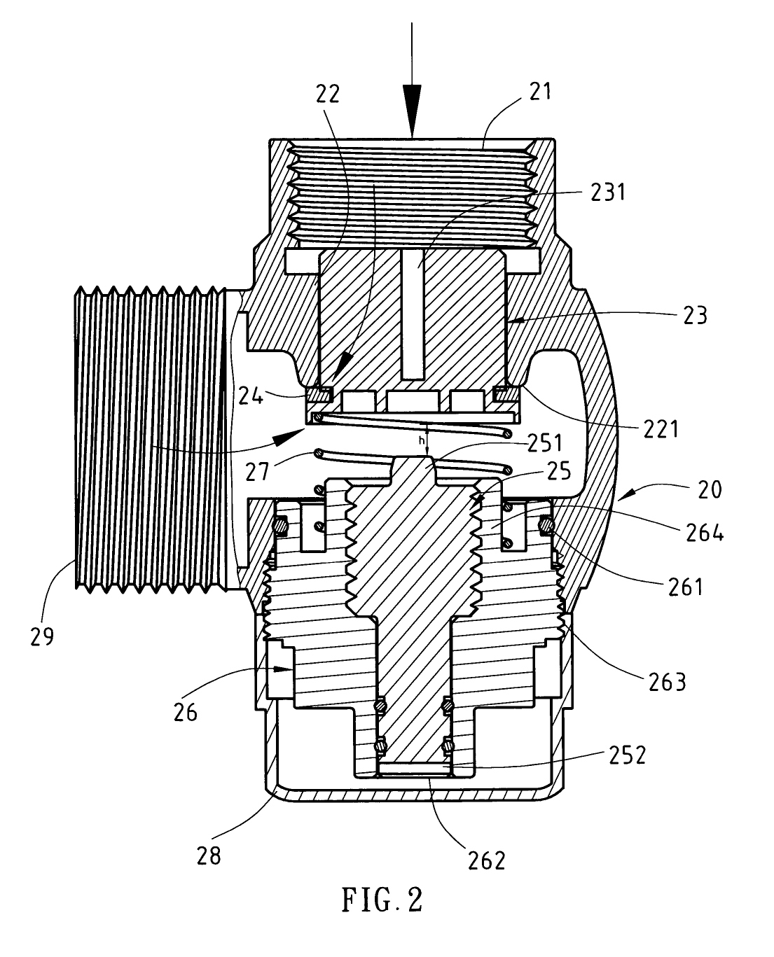

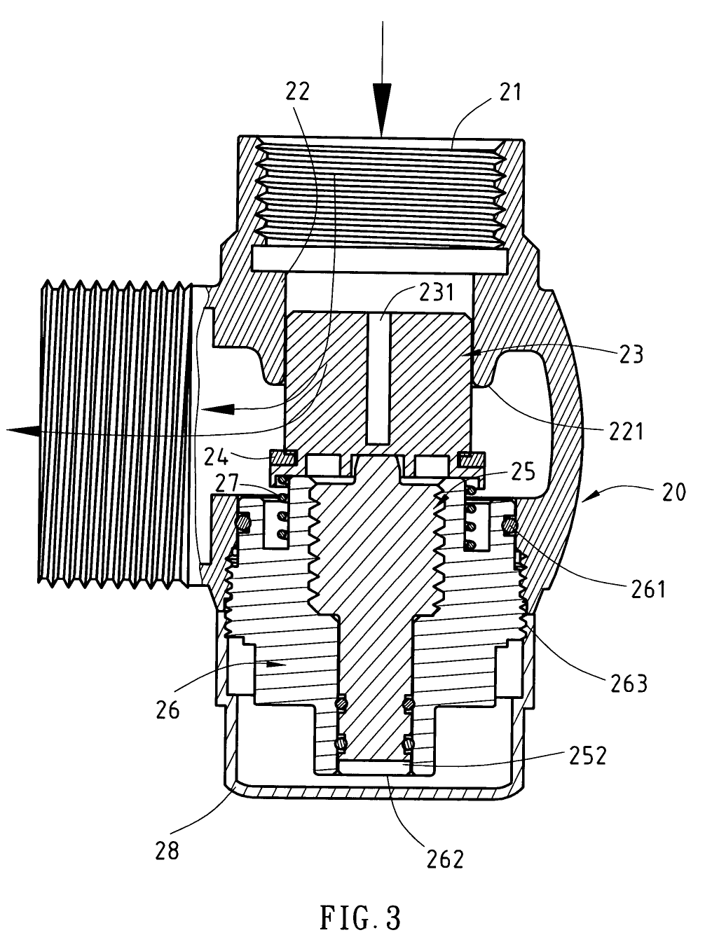

Refer to FIGS. 2 and 3 for an embodiment of the control stop of the invention. It includes a body 20 to couple with a water inlet 21 to form an orifice 22 which houses a plug 23. The plug 23 has one end remote from the water inlet 21 to be coupled with a retaining ring 24. Beneath the plug 23, there is a water regulation rod 25 which is screwed on a seat 26. The water regulation rod 25 has a strut 251 on one end and a cavity 252 on other end to be coupled with a tool such as a screw driver for operation. The seat 26 is screwed on the body 20 on one end remote from the water inlet 21. The seat 26 also is coupled with a seal ring 261 on other end close to the water inlet 21 and has an opening 262 on the opposite end to receive the tool to engage with the cavity 252 to do turning and operation. The seat 26 has external screw threads 263 around the end where the opening 262 is formed couple with a cap 28 which also presses one end of the body 20 remote from the water inlet 21. An elastic element 27 is provided which has one end coupled on a post 264 located on the seat 26 and other end pressing the bottom of the plug 23.

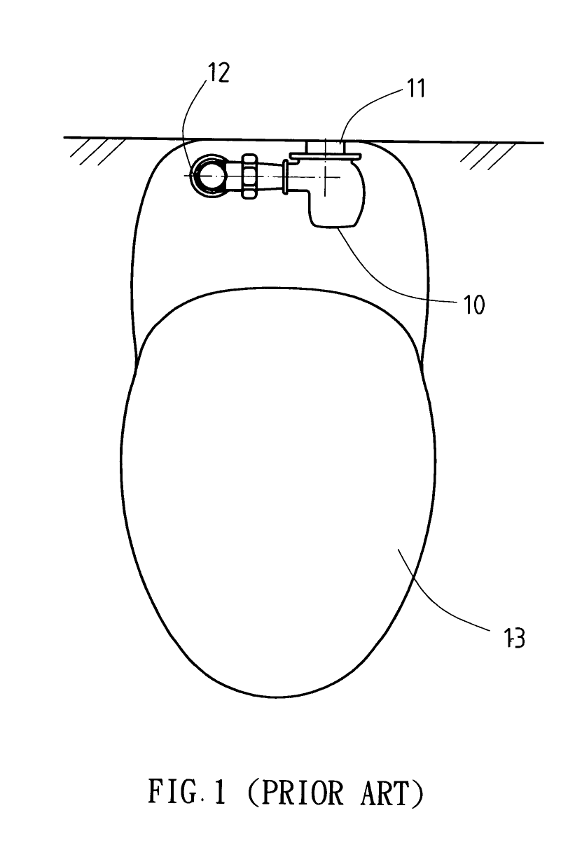

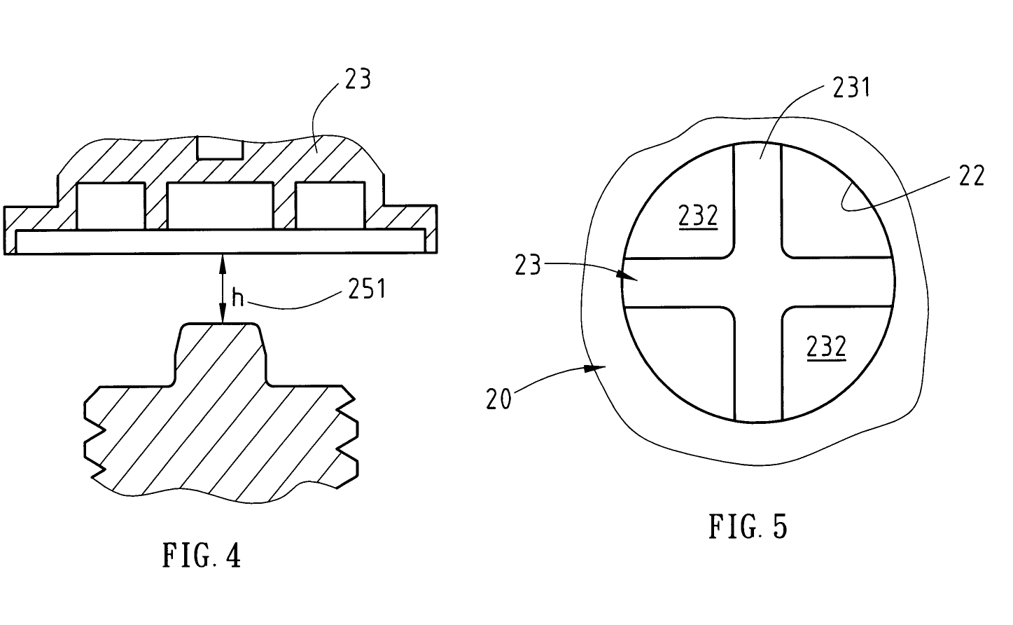

Refer to FIGS. 2 and 3 for the operating conditions of the invention. After the cap 28 is removed, the water regulation rod 25 may be turned clockwise or counterclockwise by inserting a tool such as a screw driver in the cavity 252 of the water regulation rod 25 to form a gap h between other end of the strut 251 and the bottom of the plug 23 as shown in FIG. 4. When a flush valve 12 coupled on the rear end of the control stop (referring to FIG. 1) is not opened for flushing, the plug 23 is pushed upwards by the elastic element 27 located thereunder so that the retaining ring 24 seals an outer bottom end 221 of the orifice 22, water does not enter from the water inlet 21 to a water outlet 29. On the contrary, when the flush valve 12 is opened for flushing, alteration of water pressure resulting water flowing from the water inlet 21 pushes the retaining ring 24 and the plug 23 downwards to compress the elastic element 27. The downward movement of the plug 23 is stopped by the strut 251 on the top end of the water regulation rod 25. The downward displacement equals to the distance h of the strut 251 and the bottom of the plug 23 previously formed, namely the interval between the top surface of the retaining ring 24 and the outer bottom end 221 of the orifice 22. Hence by screwing the water regulation rod 25 upwards or downwards, the distance between the strut 251 and the plug 23 may be adjusted to control water intake quantity. Referring to FIG. 2, when the flush valve is not flushing, the internal pressure of the water outlet 29 in the body 20 is greater than the pressure of the water inlet 21, hence the plug 23 is pushed upwards by the elastic element 27. The retaining ring 24 seals the outer bottom end 221 of the orifice 221 to stop flushing. Therefore in the non-flushing condition, water flow is blocked between the water inlet 21 and water outlet 29, back siphonage can be prevented and sewage cannot flow back to the water source,

In the embodiment of the invention, the plug 23 may have a cross rib 231 on the one end facing the water inlet 21 to form a plurality of spaced inlet openings 232 with the wall of the orifice 22 so that water flow from the water inlet 21 can be divided, channeled and stabilized as shown in FIG. 4.

While the preferred embodiment of the invention has been set forth for the purpose of disclosure, modifications of the disclosed embodiment of the invention as well as other embodiment thereof may occur to those skilled in the art. Accordingly, the appended claims are intended to cover all embodiments which do not depart from the spirit and scope of the invention.

1-8. (canceled)

9. A control stop comprising:
a) a body having:
i) a water inlet;
ii) an orifice located on an interior of the body adjacent to the water inlet; and
iii) a water outlet communicating with the water inlet through the orifice;
b) a plug inserted into the orifice movable between sealed and open positions;
c) a retaining ring located on a bottom of the plug;
d) a seat is connected to the body on a side opposite the water inlet and having an opening and a post located on a first end thereof;
e) a water regulation rod adjustably located in the opening of the seat, the water regulation rod limiting a distance that the plug moves between the sealed position and the open position; and
f) an elastic element having a first end connected to the post of the seat and a second end pressing against a bottom of the plug,
wherein, when the plug is located in the sealed position, the retaining ring engages a bottom of the orifice forming a seal there between, and when the plug is located in the open position, the retaining ring is spaced apart from the bottom of the orifice and a first end of the water regulation rod engaging the bottom of the plug.

10. The control stop according to claim 9, wherein the water regulation rod has an operation end located on a second end thereof for adjusting a distance between the first end of the water regulation rod and the bottom of the plug, when the plug is located in the sealed position.

11. The control stop according to claim 10, wherein the operation end of the water regulation rod has a cavity.

12. The control stop according to claim 10, wherein operation end of the water regulation rod is located in the opening of the seat and accessible from an exterior of the body.

13. The control stop according to claim 9, wherein the elastic element is a spring.

14. The control stop according to claim 9, further comprising a cap connected to the seat and engaging the body, and covering the operation end of the water regulation rod.

15. The control stop according to claim 9, wherein the plug has a cross rib located on an end adjacent to the water inlet.

16. The control stop according to claim 15, wherein the cross ribs and an interior wall of the orifice forming a plurality of water inlet openings.
